(19) United States
(12) Patent Application Publication
(10) Pub. No.: US 2023/0186156 A1
(43) Pub. Date: Jun. 15, 2023

(54) METHODS AND APPARATUS TO TRAIN A MODEL USING ATTESTATION DATA

(71) Applicant: Intel Corporation, Santa Clara, CA (US)

(72) Inventors: Ned Smith, Beaverton, OR (US); Rita Chattopadhyay, Chandler, AZ (US)

(21) Appl. No.: 17/917,335

(22) PCT Filed: May 17, 2021
(86) PCT No.: PCT/US2021/032784

§ 371 Date: Oct. 6, 2022

Related U.S. Application Data
(60) Provisional application No. 63/026,666, filed on May 18, 2020.

(51) Int. Cl. G06N 20/00; G06N 5/02

(52) U.S. Cl. CPC G06N 20/00; G06N 5/02

(57) ABSTRACT

Methods, apparatus, systems and articles of manufacture to train a model using attestation data are disclosed. An example apparatus includes memory, instructions, and at least one processor to execute machine readable instructions to at least access training data originating from an edge device, the training data including telemetry information and attestation information, determine a weighting value to be used for the telemetry information based on the attestation information associated with the edge device, and train a machine learning model based on the telemetry information and the weighting value.

### RELATED APPLICATIONS

This U.S. Provisional Patent Application Ser. No. 63/026,666, which was filed on May 18, 2020, is hereby incorporated herein by reference in its entirety. Priority to U.S. Patent Application Ser. No. 63/026,666 is hereby claimed.

### FIELD OF THE DISCLOSURE

This disclosure relates generally to machine learning, and, more particularly, to methods and apparatus to train a model using attestation data.

### BACKGROUND

Edge computing, at a general level, refers to the transition of compute and storage resources closer to endpoint devices (e.g., consumer computing devices, user equipment, etc.) in order to optimize total cost of ownership, reduce application latency, improve service capabilities, and improve compliance with data privacy or security requirements. Edge computing may, in some scenarios, provide a cloud-like distributed service that offers orchestration and management for applications among many types of storage and compute resources. As a result, some implementations of edge computing have been referred to as the “edge cloud” or the “fog,” as powerful computing resources previously available only in large remote data centers are moved closer to endpoints and made available for use by consumers at the “edge” of the network.

### BRIEF DESCRIPTION OF THE DRAWINGS

FIG. 1 illustrates an overview of an edge cloud configuration for edge computing.

FIG. 2 illustrates operational layers among endpoints, an edge cloud, and cloud computing environments.

FIG. 3 illustrates an example approach for networking and services in an edge computing system.

FIG. 4 is a block diagram of an example edge deployment showing integrated Attestation Information Object (AIO) data

FIG. 5 is a block diagram of an object or system (or subsystem) of an edge device, including an attestation information object.

FIG. 6 is a block diagram representing an example environment of use including a computing device constructed in accordance with the teachings of this disclosure.

FIG. 7 is a flowchart representative of machine readable instructions which may be executed to implement the example computing device of FIG. 6.

FIG. 8 is a block diagram of an example processor platform structured to execute the instructions of FIG. 7 to implement the example computing device of FIG. 6.

FIG. 9 provides an overview of example components for compute deployed at a compute node in an edge computing system.

FIG. 10 provides a further overview of example components within a computing device in an edge computing system.

FIG. 11 is a block diagram of an example software distribution platform to distribute software (e.g., software corresponding to the example computer readable instructions of FIG. 7) to client devices such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy customers).

The figures are not to scale. Instead, the thickness of the layers or regions may be enlarged in the drawings. In general, the same reference numbers will be used throughout the drawing(s) and accompanying written description to refer to the same or like parts. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real-world imperfections. As used herein “substantially real time” refers to occurrence in a near instantaneous manner recognizing there may be real world delays for computing time, transmission, etc. Thus, unless otherwise specified, “substantially real time” refers to real time+/−1 second.

### DETAILED DESCRIPTION

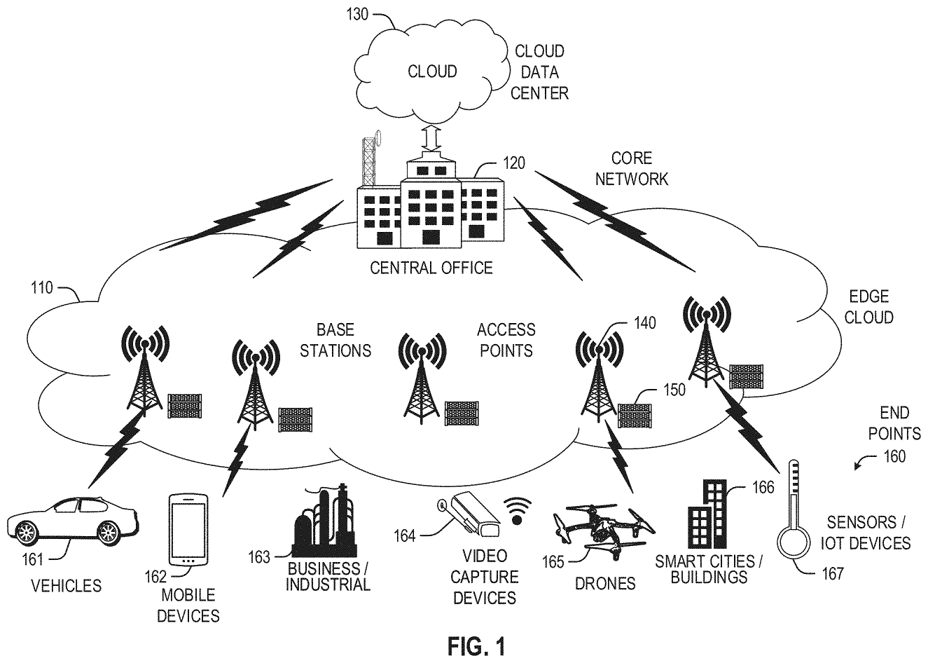

FIG. 1 is a block diagram 100 showing an overview of a configuration for edge computing, which includes a layer of processing referred to in many of the following examples as an “edge cloud”. As shown, the edge cloud 110 is co-located at an edge location, such as an access point or base station 140, a local processing hub 150, or a central office 120, and thus may include multiple entities, devices, and equipment instances. The edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the edge cloud 110 are critical to providing ultra-low latency response times for services and functions used by the endpoint data sources 160 as well as reduce network backhaul traffic from the edge cloud 110 toward cloud data center 130 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of service and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

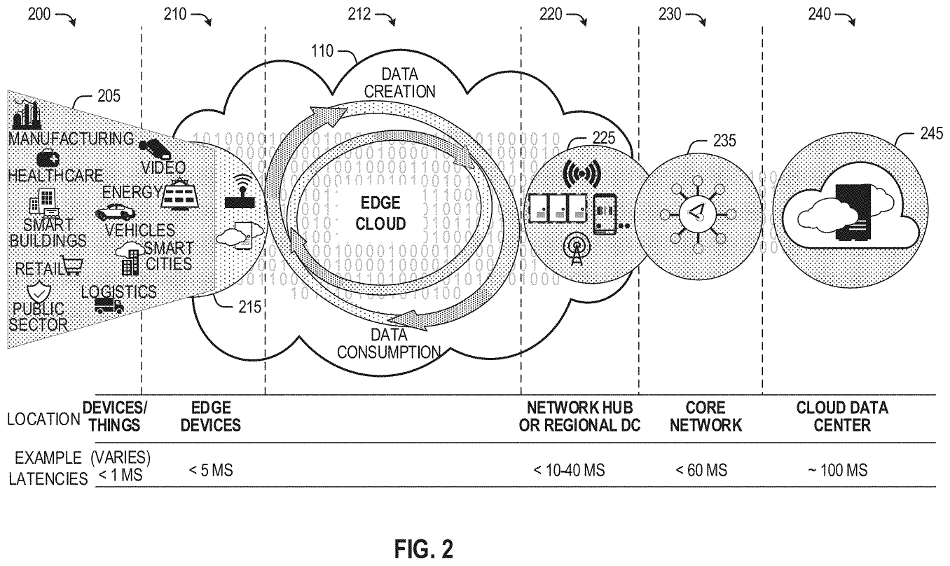

FIG. 2 illustrates operational layers among endpoints, an edge cloud, and cloud computing environments. Specifically, FIG. 2 depicts examples of computational use cases 205, utilizing the edge cloud 110 among multiple illustrative layers of network computing. The layers begin at an endpoint (devices and things) layer 200, which accesses the edge cloud 110 to conduct data creation, analysis, and data consumption activities. The edge cloud 110 may span multiple network layers, such as an edge devices layer 210 having gateways, on-premise servers, or network equipment (nodes 215) located in physically proximate edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the edge cloud 110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 200, under 5 ms at the edge devices layer 210, to even between 10 to 40 ms when communicating with nodes at the network access layer 220. Beyond the edge cloud 110 are core network 230 and cloud data center 240 layers, each with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 235 or a cloud data center 245, a central office or content data network may be considered as being located within a “near edge” layer (“near” to the cloud, having high latency values when communicating with the devices and endpoints of the use cases 205), whereas an access point, base station, on-premise server, or network gateway may be considered as located within a “far edge” layer (“far” from the cloud, having low latency values when communicating with the devices and endpoints of the use cases 205). It will be understood that other categorizations of a particular network layer as constituting a “close”, “local”, “near”, “middle”, or “far” edge may be based on latency, distance, number of network hops, or other measurable characteristics, as measured from a source in any of the network layers 200-240.

The various use cases 205 may access resources under usage pressure from incoming streams, due to multiple services utilizing the edge cloud. To achieve results with low latency, the services executed within the edge cloud 110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 110 (network layers 200-240), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 110.

As such, the edge cloud 110 is formed from network components and functional features operated by and within edge gateway nodes, edge aggregation nodes, or other edge compute nodes among network layers 210-230. The edge cloud 110 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 110 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

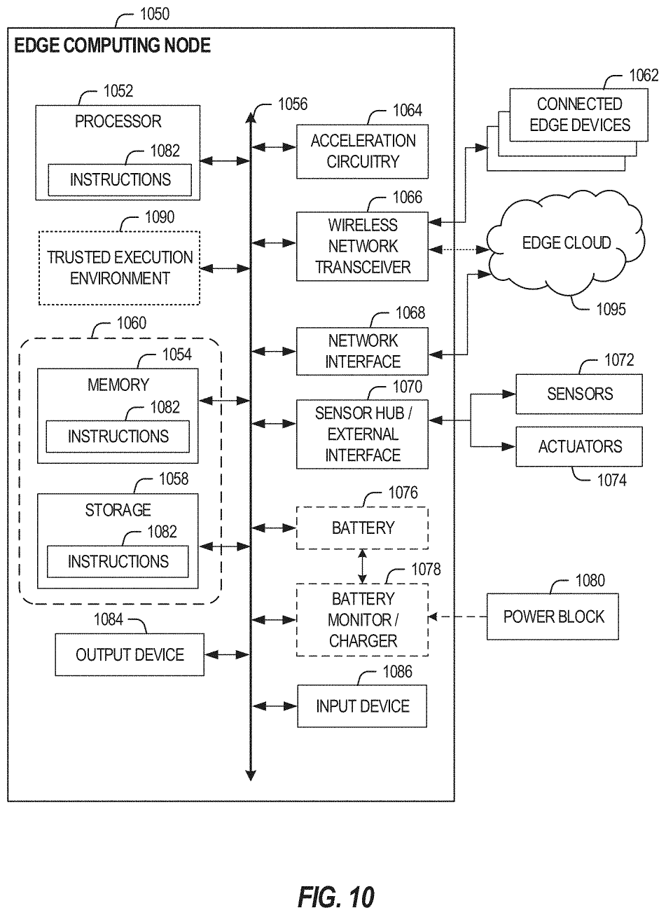

The network components of the edge cloud 110 may be servers, multi-tenant servers, appliance computing devices, and/or any other type of computing devices. For example, the edge cloud 110 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 10. The edge cloud 110 may also include one or more servers and/or one or more multi-tenant servers. Such a server may include an operating system and implement a virtual computing environment. A virtual computing environment may include a hypervisor managing (e.g., spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

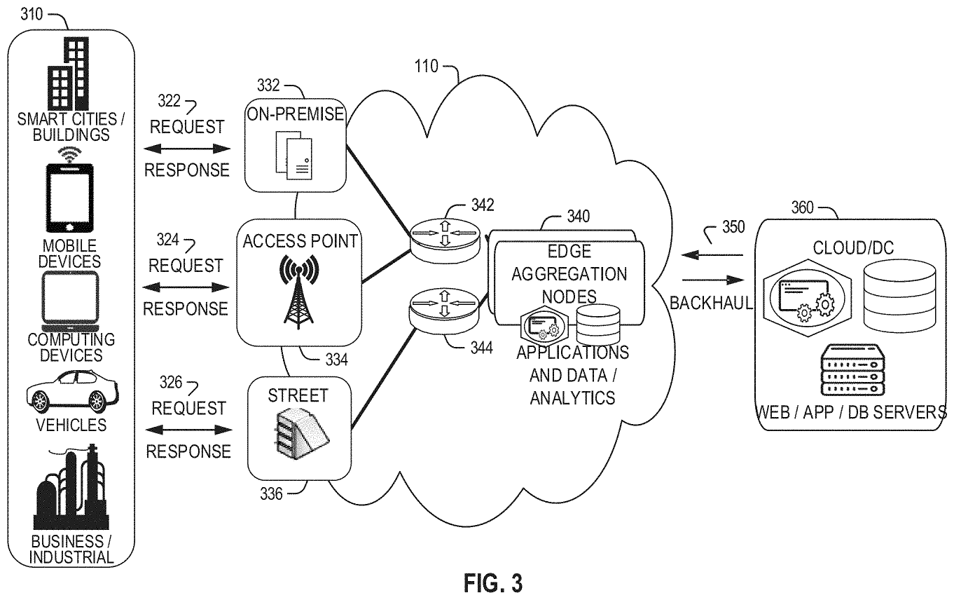

In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the edge cloud 110 to aggregate traffic and requests. Thus, within the edge cloud 110, the TSP may deploy various compute and storage resources, such as at edge aggregation nodes 340, to provide requested content. The edge aggregation nodes 340 and other systems of the edge cloud 110 are connected to a cloud or data center 360, which uses a backhaul network 350 to fulfill higher-latency requests from a cloud/data center for websites, applications, database servers, etc. Additional or consolidated instances of the edge aggregation nodes 340 and the aggregation points 342, 344, including those deployed on a single server framework, may also be present within the edge cloud 110 or other areas of the TSP infrastructure.

Edge computing, at a general level, refers to the transition of compute and storage resources closer to endpoint devices (e.g., consumer computing devices, user equipment, etc.) in order to optimize total cost of ownership, reduce application latency, improve service capabilities, and improve compliance with data privacy or security requirements. Edge computing may, in some scenarios, provide a cloud-like distributed service that offers orchestration and management for applications among many types of storage and compute resources. As a result, some implementations of edge computing have been referred to as the “edge cloud” or the “fog,” as powerful computing resources previously available only in large remote data centers are moved closer to endpoints and made available for use by consumers at the “edge” of the network.

In some examples, edge devices in an edge computing infrastructure include one or more sensors that enable reporting of data to another device (e.g., an aggregator) for processing. The processing, in some examples, involves application of an artificial intelligence (AI) and/or a machine learning (ML) model to generate an output. Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist including, for example, Random Forest models, Support Vector Machines (SVMs), Neural Networks, Convolutional Neural Network (CNN), etc. Different machine learning models/architectures may be more well-suited to performing particular tasks. For example, some machine learning models/architectures may be more suited for classification tasks, as opposed to output prediction, language processing, etc. In examples disclosed herein, a machine learning model for classification of inputs is used. However, any other types of machine learning models could additionally or alternatively be used.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labeling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained using stochastic gradient descent. However, any other training algorithm may additionally or alternatively be used. In examples disclosed herein, training is performed until an acceptable amount of error is achieved. In examples disclosed herein, training is performed at an aggregator device that receives and/or aggregates data originating from one or more sensor platforms. Training is performed using hyperparameters that control how the learning is performed (e.g., a learning rate, a number of layers to be used in the machine learning model, etc.).

Training of the machine learning model is performed using training data. In examples disclosed herein, the training data originates from devices within the edge ecosystem. The quality and/or the performance of ML/AI models largely depends on the quality of the training data used to build the model as well as the quality and/or reliability of the data presented to the learned ML/AI model during run time and inference. Once training is complete, the model is deployed for use as an executable construct that processes an input and provides an output based on the network of nodes and connections defined in the model.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

As noted above, training of the machine learning model is performed using training data. In general, the work of ensuring and/or verifying that training data is valid is performed by system engineers and/or data scientists who, based on the way the data is collected (e.g., sensor health, operational characteristics, other metrics related to the data, etc.), certify the quality of the training data according to manual practices and procedures.

However, there are drawbacks to this approach to data quality assurance. For example, the health of a sensor supplying data to the model for processing may deteriorate over time (following an initial deployment). That is, even if the quality of the data from the sensor was good during training time, it may not be valid at test/inference time. Further, even during training time, a sensor used to establish a ground truth may not have been operating in a known-good condition. It is quite possible, that some sources of data are noisier and less reliable, but undetected, resulting in skewed training data.

Example approaches disclosed herein utilize dynamic assessment of sensor (endpoint) operational state as a pre-requisite to entering training or data collection modes, and instrument the trained ML/AI model with reliability weighting factors based on the different sources of data and data collection environments, so that the ML/AI models can provide differential weighting to the trained models based on an understanding of the source of information, sensor/operational parameters, physical features, reliability metrics, and/or other context revealed through attestation. Weighting metrics can be applied both during training and at inference time. Such weighting makes the models adaptive and aware of data quality and can be applied for each data source. The weighting also enables better performance and robustness (due to increased noise tolerance) and prevents the security, safety, and resiliency pitfalls that stem from too great of a dependence on unreliable training and data set sources.

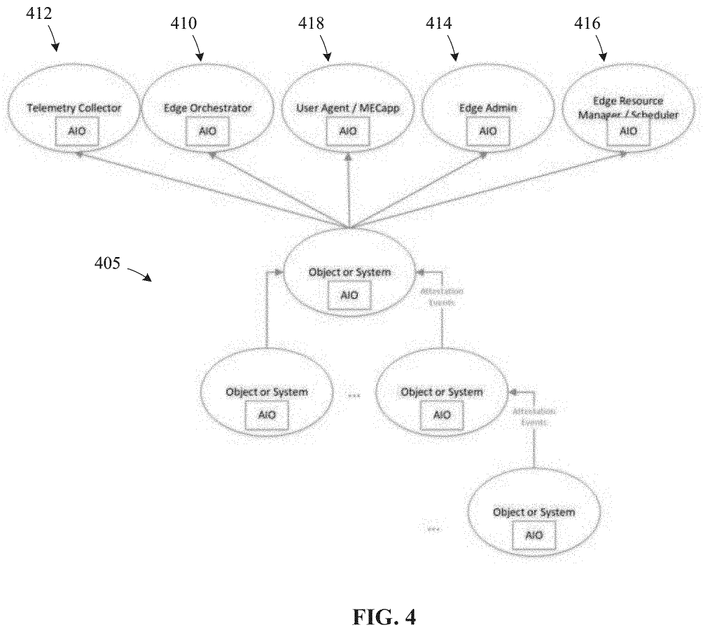

FIG. 4 is a block diagram of an example edge deployment showing integrated Attestation Information Object (AIO) data. The AIO architecture includes several attestation objects 405 that have been integrated into IoT, Edge, and/or Cloud deployments such that they can collect and report attestation data following a declarative information processing model.

The AIO may be integrated into the data object interface directly by supplying an attestable key that is used with the interface security mechanisms. For example, the interface may rely on a Transport Layer Security (TLS) protected session such as Constrained Application Protocol (CoAPS), HyperText Transfer Protocol Secure (HTTPS), or a TLS Virtual Private Network (VPN). Alternatively, the data object may protect data values end-to-end using Object Security for Constrained RESTful Environments (OSCORE), Web Services Security (WS-Security), CBOR Object Signing and Encryption (COSE), JSON Object Signing and Encryption (JOSE), X.506 certificates, and/or CMS data encodings that support signing and encryption. The verifier may detect the use of an attestable key and query the AIO interface to obtain Evidence. Alternatively, Evidence may be integrated into the data object protocol directly.

An example edge ecosystem may include edge operations/services such as orchestration 410, telemetry 412, administration 414, and manageability/scheduling 416. The example edge ecosystem may include user applications and/or groups of users 418. The example edge ecosystem may include a rich set of interconnected and interrelated services, microservices, FaaS services, edge-lets, data pools, cloudlets, etc. that may be arranged in various configurations such that there may be a hierarchical system of input and output dependency. An example arrangement of such objects 405 is shown in FIG. 4. The AIO subsystem object may be integrated with each data and/or services object such that an attestation risk assessment can be applied system wide, to a sub-system or local to a specific node.

Examples disclosed herein utilize attestation mechanisms to provide attestation metadata to the ML/AI models when training the model, as well as when performing inference. In examples disclosed herein, training data is weighted differentially depending on the quality and/or correctness of sensor data, as indicated by the attestation data. The model is adjusted (weighted) to rely more on data originating from more reliable and compliant data sources and less on sources that have less reliable, less compliant data sources.

The AIO data may include information about the health of the sensor, data validity methods at the source, time of data collection, probability that the data is tampered with, etc. Use of such attestation information is particularly useful in sensitive environments, such as banks, health care environments, manufacturing plants, etc.

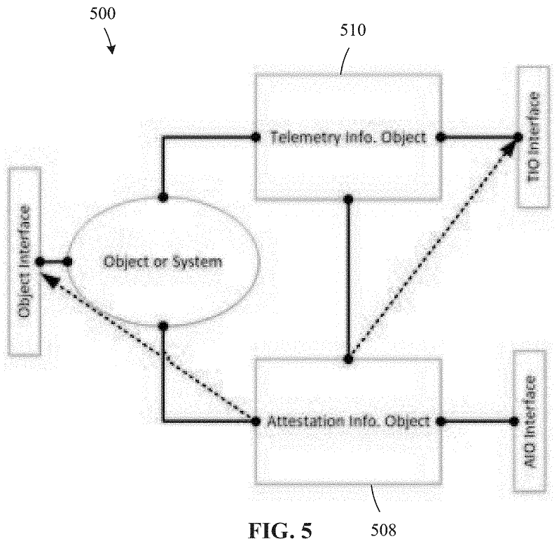

FIG. 5 is a block diagram of an object or system (or subsystem) of an edge device 500, including an attestation information object 508. Each object or system (or subsystem) of an edge device is associated with an attestation information object (AIO). An AIO interface is associated with the AIO object.

Examples of subsystems of an edge (e.g., peripheral) device, with which AIO may be associated include, but are not limited to: a Network Interface Card (NIC), an audio interface such as (M.2), a co-processor such as a Graphics Processing Unit (GPU), a portable security unit, a power supply unit, a host bus adapter (HBA), an FPGA, a crypto or compression offload unit such as Intel® QuickAssist Technology (QAT), etc. In some examples, the object or system may be a subsystem of a SoC IP block such as an IO controller, memory controller, bus master controller or a subsystem of a CPU array controller, uncore or as a motherboard IP block or as a subsystem of a CPU core, CPU debug subsystem, CPU performance monitoring subsystem etc.

The AIO (and its interface) enables flexible composition and orchestration of security and trustworthiness of objects, systems, or their subsystems. As objects or systems are aggregated or disaggregated into various compositions, their associated AIOs may thus aggregate or disaggregate in a similar manner which permits a separation of attestation concerns between how an object delivers its service, from how that object becomes part of a trusted system. The separation of concerns permits a granular orchestration of security and trust in accordance with security policies and objectives, and thus separate from performance, power, and other objectives that drive resource allocation decisions. Thus, a Single Sign On (SSO) policy objective may be associated with an entire organization, and once signed in at a level of aggregation, an entire subsystem of objects may be authenticated and trusted to operate as one domain continuum, even though, for performance or quality management purposes, some parts of that continuum may be prioritized or deprioritized for resource allocation.

AIO is a building block for composing trustworthy telemetry from objects and systems of objects since resource allocation and deallocation decisions in an agile edge environment depend critically on telemetry information provided by a telemetry information object 510, and that telemetry too may need to be trusted (at least as not being malicious or mischievous), AIO associated with an object or subsystem may also protect or attest-to the trustworthiness of such telemetry as shown in FIG. 5. In some examples, an object and/or the data within that object may be very sensitive, while the attestation and/or telemetry data for that object may not be sensitive. For example, the object may represent a key value store that includes personally identifiable information (e.g., sensitive information), yet the telemetry over its operation may be freely shared within a domain because a knowledge of telemetry does not reveal the contents of the object. Accordingly, the attestation over an object, and over the telemetry data associated with that object, may be loosely coupled without breaking the expectation that the principle of least privilege is observed.

The AIO object 508 and telemetry information object 510 shown in FIG. 5 are an example of a possible deployment approach where the telemetry collection represents data that may be used to train a model that intelligently analyzes telemetry. Example approaches disclosed herein utilize the attestation and telemetry data sources as “information objects” that implement a declarative data model. Such model lends itself to integration into popular IoT, Edge and Cloud frameworks such as LWM2M, IoTivity, OpenNESS, Multi-access Edte Computing (MEC) framework, and Kubernetes.

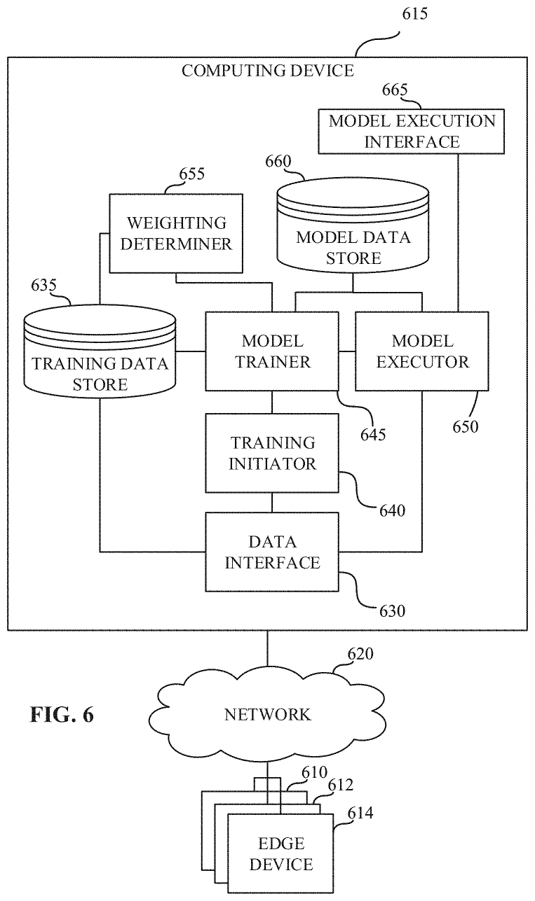

FIG. 6 is a block diagram representing an example environment of use 600 including a computing device 615 constructed in accordance with the teachings of this disclosure. The example environment 600 of FIG. 6 includes edge devices 610, 612, 614 that communicate information to a computing device 615 via a network 620. The example computing device 615 processes the data using a machine learning model to create an output. The example computing device 615 of FIG. 6 includes a data interface 630, a training data store 635, a training initiator 640, a model trainer 645, a model executor 650, a weighting determiner 655, a model data store 660, and a model execution interface 665.

The example edge devices 610, 612, 614 represent the example object or system(s) of FIGS. 4 and/or 5. In this manner, the edge device(s) 610, 612, 614 may be implemented by sensor platforms, computing devices, and/or any other device that reports attestable data. The example network 620 of the illustrated example of FIG. 6 is implemented by a packet-based network such as, for example, an Ethernet network, a wireless network, the Internet, etc. However, any other past, present, and or future type(s) of network(s) may additionally or alternatively be used.

The example data interface 630 of the illustrated example of FIG. 6 accesses data from the edge device(s) 610, 612, 614 via the network 620. The example data interface 630 relays the received data to the training data store 635 and/or to the model executor 650. In some examples, the data interface 630 is implemented using a web-accessible interface such as, for example, a representational state transfer (REST) interface, an application programming interface (API), etc. In some examples, the data interface 630 implements means for accessing.

The example training data store 635 of the illustrated example of FIG. 6 is implemented by any memory, storage device and/or storage disc for storing data such as, for example, flash memory, magnetic media, optical media, solid state memory, hard drive(s), thumb drive(s), etc. Furthermore, the data stored in the example training data store 635 may be in any data format such as, for example, binary data, comma delimited data, tab delimited data, structured query language (SQL) structures, etc. While, in the illustrated example, the training data store 635 is illustrated as a single device, the example training data store 635 and/or any other data storage devices described herein may be implemented by any number and/or type(s) of memories. In the illustrated example of FIG. 6, the example training data store 635 stores data received from the edge device(s) 610, 612, 614 via the data interface 630.

The example training initiator 640 of the illustrated example of FIG. 6 determines whether to initiate training of a machine learning model. Training may be initiated, for example, in response to a change in attestation data received from an edge device. In this manner, training may be performed in response to a change in the edge device configuration, a replacement of an edge device, etc. Re-performing such training allows the machine learning model to adapt to the changing ecosystem of edge devices. In some examples, the training initiator 640 may determine that a model is not to be retrained (e.g., to delay training of a model). Such delaying of training of a model may be beneficial if, for example, attestation data from one or more of the edge devices 610, 612, 614 identifies the device as being in a non-normal state, such as a debug mode, operating with an increase amount of noise, etc. In some examples, the training initiator 640 implements means for initiating.

The example model trainer 645 of the illustrated example of FIG. 6, in connection with the model executor 650, performs training of a machine learning model. During training, the machine learning model is stored in the model datastore 660 by the example model trainer 645. This machine learning model may later be utilized by the example model executor 650 to process incoming data received via the data interface 630. In examples disclosed herein, training is performed using Stochastic Gradient Descent. However, any other approach to training a machine learning model may additionally or alternatively be used. In some examples, the model trainer 645 implements means for training.

The example model executor 650 of the illustrated example of FIG. 6 executes the machine learning model stored in the example model data store 660. Many different types of machine learning models, such as Random Forest, Support Vector Machines, K-NN, NN, CNN, etc. that support differential weighting of the input features may be executed by the model executor 650. This provides the flexibility to the user to develop data quality aware models, avoiding the pitfall of developing models which may weigh more on a noisy sensor or source of data and perform poorly at the deployment or inference time. Differential weighing of the features/attributes for the machine learning model improves predictive performance of the ML/DL models. In some examples, the model executor 650 implements means for executing.

The example weighting determiner 655 of the illustrated example of FIG. 6 prepares weighting values for the training data based on the attestation data included therein. In examples disclosed herein, the weighting determiner 655 prepares the weighting values based on domain knowledge. However, any other approach to determining weighting values may additionally or alternatively be used. For example, weighting values may be determined based on a relative importance of a sensor for a particular classification to be performed by the machine learning model, an understanding of the source of information, sensor/operational parameters, physical features, reliability metrics, and/or other context revealed through attestation.

In examples disclosed herein, the weighting determiner 655 generates weights for its different data sources to enable training of the ML/DL models using the differentially weighted data. This differential weighting enables data quality aware models that have better performance and robustness to noise. This also enables the user to modify the weight of any source, based upon any new information and retrain the ML models, to make them quickly adaptive to any real time crisis (e.g., a failure of a sensor). In some examples, the weighting determiner 655 implements means for determining.

The example model data store 660 of the illustrated example of FIG. 6 is implemented by any memory, storage device and/or storage disc for storing data such as, for example, flash memory, magnetic media, optical media, solid state memory, hard drive(s), thumb drive(s), etc. Furthermore, the data stored in the example model data store 660 may be in any data format such as, for example, binary data, comma delimited data, tab delimited data, structured query language (SQL) structures, etc. While, in the illustrated example, the model data store 660 is illustrated as a single device, the example model data store 660 and/or any other data storage devices described herein may be implemented by any number and/or type(s) of memories. In the illustrated example of FIG. 6, the example model data store 660 stores the model trained by the model trainer 645 and executed by the model executor 650.

The example model execution interface 665 of the illustrated example of FIG. 6 enables an output of the results of the execution of the model by the model executor 650. The model execution interface 665 may present such results to, for example, a user of the edge device(s) 610, 612, 614, a system administrator, etc. In some examples, the trained model is distributed by the model execution interface 665 from a first computing device (e.g., where training is performed) to a second computing device (e.g., where inference is performed). Such distribution may be performed over the edge cloud 110 to, for example, distribute the model from a first computing device where training is performed (e.g., a device within the network hub 225 of FIG. 2, a device within the core network 235 of FIG. 2, a device within the cloud data center 245 of FIG. 2, etc.) to a second computing device where inference is to be performed (e.g., one or more of the edge devices 210 of FIG. 2, one or more of the devices 200 of FIG. 2, etc.). Such distribution may be performed periodically (e.g., daily, weekly, hourly, etc.) and/or a-periodically (e.g., in response to a need to perform inference, in response to completion of training of a model, etc.). In some examples, the model execution interface 665 may implement means for distributing.

In some examples, an example computing device may be implemented with fewer of the components of the example computing device 615 of FIG. 6. In the illustrated example of FIG. 6, a first computing device (e.g., a computing device implementing each of the components of the example computing device 615 of FIG. 6) is used for both training and execution of a machine learning model. In some examples, computing devices may be implemented specifically for training of a machine learning model, while in some other examples, computing devices may be implemented specifically for execution of the machine learning model.

In some examples, after training of a machine learning model, the model may be distributed to other computing devices (e.g., a second computing device) for inference. In such an example, the second computing device may omit components related to the training of the machine learning model such as, for example, the training initiator 640, the training data store 635, and the model trainer 645. Training of machine learning models is typically more resource intensive than execution of those machine learning models. As a result, the second computing device (which does not perform training of the machine learning model(s), but instead only receives the model from another computing device and performs inference using the received model) may be implemented using lower power and/or less resource intensive computing equipment.

In some examples, a computing device (e.g., a third computing device) may be implemented without inference capabilities, and instead, may be designed specifically for training of machine learning models. For example, the third computing device may be implemented without the model execution interface 665.

While an example manner of implementing the example computing device 615 is illustrated in FIG. 6, one or more of the elements, processes and/or devices illustrated in FIG. 6 may be combined, divided, re-arranged, omitted, eliminated and/or implemented in any other way. Further, the example data interface 630, the example training initiator 640, the example model trainer 645, the example model executor 650, the example weighting determiner 655, the example model execution interface 665, and/or, more generally, the example computing device 615 of FIG. 6 may be implemented by hardware, software, firmware and/or any combination of hardware, software and/or firmware. Thus, for example, any of the example data interface 630, the example training initiator 640, the example model trainer 645, the example model executor 650, the example weighting determiner 655, the example model execution interface 665, and/or, more generally, the example computing device 615 of FIG. 6 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example data interface 630, the example training initiator 640, the example model trainer 645, the example model executor 650, the example weighting determiner 655, the example model execution interface 665, and/or, more generally, the example computing device 615 of FIG. 6 is/are hereby expressly defined to include a non-transitory computer readable storage device or storage disk such as a memory, a digital versatile disk (DVD), a compact disk (CD), a Blu-ray disk, etc. including the software and/or firmware. Further still, the example computing device 615 of FIG. 6 may include one or more elements, processes and/or devices in addition to, or instead of, those illustrated in FIG. 4, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

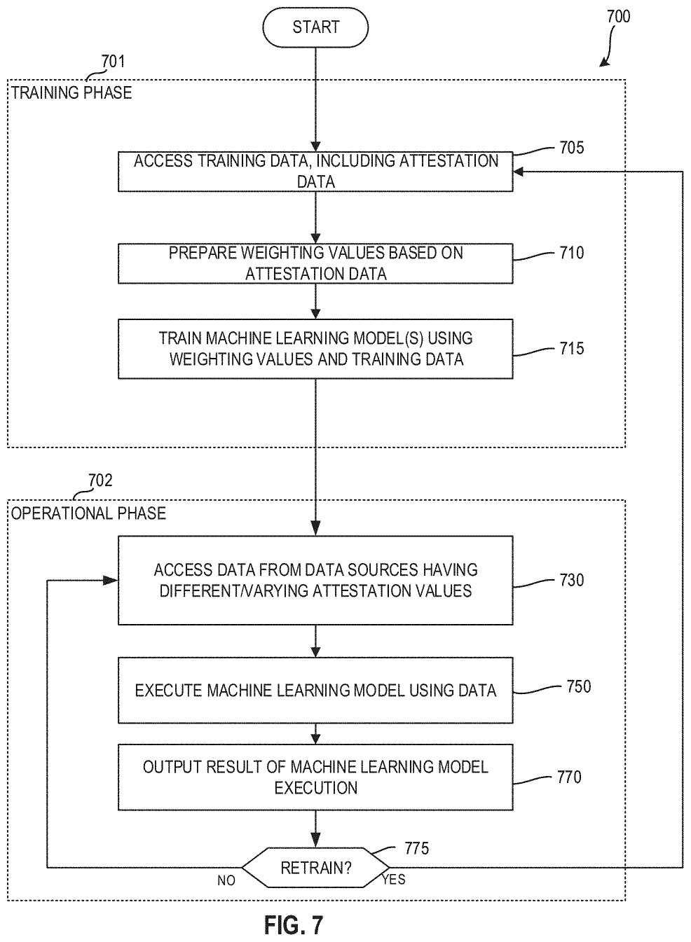

A flowchart representative of example hardware logic, machine readable instructions, hardware implemented state machines, and/or any combination thereof for implementing the example computing device 615 of FIG. 6 is shown in FIG. 7. The machine readable instructions may be one or more executable programs or portion(s) of an executable program for execution by a computer processor and/or processor circuitry, such as the processor 1012 shown in the example processor platform 1000 discussed below in connection with FIG. 10. The program may be embodied in software stored on a non-transitory computer readable storage medium such as a CD-ROM, a floppy disk, a hard drive, a DVD, a Blu-ray disk, or a memory associated with the processor 1012, but the entire program and/or parts thereof could alternatively be executed by a device other than the processor 1012 and/or embodied in firmware or dedicated hardware. Further, although the example program is described with reference to the flowchart illustrated in FIG. 7, many other methods of implementing the example computing device 615 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIG. 7 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 7 is a flowchart representative of machine readable instructions which may be executed to implement the example computing device 615 of FIG. 6. The example process 700 of FIG. 7 includes a training phase 701 and an operational phase 702. The example process 700 of FIG. 7 begins when the computing device 615 is initialized. Such initialization may occur, for example, upon startup of the example computing device 615, at the direction of a user, etc. The example computing device 615 enters the training phase 701, where the example data interface 630 accesses training data including attestation data. (Block 705). In examples disclosed herein, the training data is received from the edge devices 610, 612, 614, via the network 620.

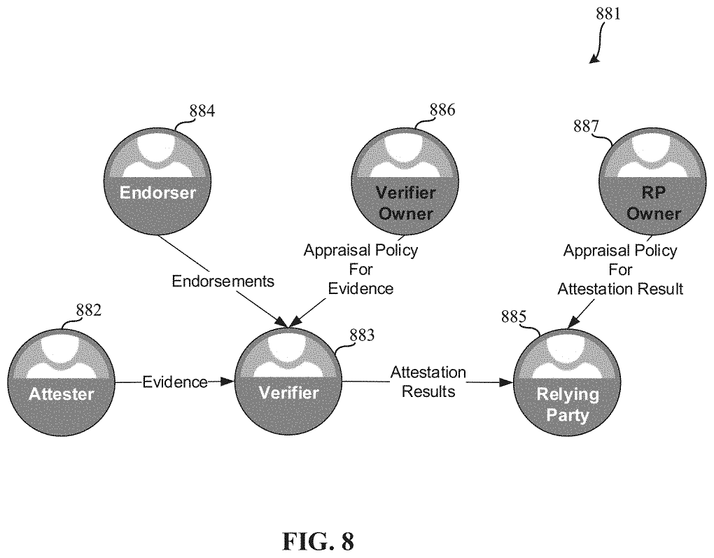

FIG. 8 is a block diagram of a canonical Attestation Architecture 881. The example attestation architecture 881 of FIG. 8 is a canonical model for a broad range of attestation scenarios. Different scenarios may require topological and deployment specific considerations. The primary objective of attestation roles architecture is to define the functions pertaining to the particular roles and the information exchanged between them. Attestation roles may be combined and separated as needed to accommodate the requirements of a particular deployment or use case.

The basic functions of the attestation architecture are creation, conveyance, and appraisal of attestation evidence. In the illustrated example of FIG. 8, an attester 882 creates attestation Evidence that is conveyed to a Verifier 883 for appraisal. The appraisals performed by the Verifier 883 compare Evidence (provided by the attester 882) with Endorsements (provided by an endorser 884). Endorsements represent the possible values that the Verifier 883 expects to find in the Evidence. In examples disclosed herein, the endorsers 884 may be represented by manufacturers, vendors, and/or other supply entities. There can be multiple forms of appraisal (e.g., software integrity verification, device composition and configuration verification, device identity and provenance verification). Attestation Results are the output of appraisals that are conveyed to a Relying Party 885. Attestation Results provide the basis by which the Relying Party 885 may determine a level of confidence to place in the operations that follow.

This architecture defines attestation Roles (e.g., the Attester 882, the Verifier 883, the Endorser 884, the Relying Party 885, a Verifier Owner 886, and/or a Relying Party Owner 887) and the messages they exchange. Message structure and the various ways in which Roles may be hosted, combined and divided is also part of the architecture. Messages are protected either by a data structure approach (e.g., X.509 certificates, RFC8392) or by a conveyance protocol (e.g., RFC5246).

Returning to FIG. 7, the example weighting determiner 655 prepares weighting values for the training data based on the attestation data included therein. (Block 710). In examples disclosed herein, the weighting determiner 655 prepares the weighting values based on domain knowledge. However, any other approach to determining weighting values may additionally or alternatively be used. For example, weighting values may be determined based on a relative importance of a sensor for a particular classification to be performed by the machine learning model, an understanding of the source of information, sensor and/or operational parameters, physical features, reliability metrics, and/or other context revealed through attestation.

In examples disclosed herein, attestation may refer to “Attestation Results” per the architecture 880 of FIG. 8. Attestation Results may be formatted as a collection of Claims (e.g., formatted according to an IETF RATS architecture) and may include non-binary values (e.g., weighted values and/or probabilistic values). These “Weighted Attestation Results” may be more readily integrated into a training phase 701 as probabilistic training data (e.g., at block 705) and/or as weighted values that “tweak” or adjusts the actual/observed data set (e.g., at block 710). In the illustrated example of FIG. 7, block 705 is sequenced before block 710. However, in some examples, it may be possible for an attestation Verifier to supply Attestation Results in a format suitable for use by the weighting determiner 655 at block 710. In some examples, block 705 may accept “traditional” Attestation Results having binary (True/False) or scalar data.

The example model trainer 645 trains a machine learning model using the weighting values provided by the weighting determiner 655 and training data stored in the training data store 660. (Block 715). The resulting model is stored in the model data store 660. In examples disclosed herein, the machine learning model is trained using stochastic gradient descent. However, any other training algorithm may additionally or alternatively be used. As a result of the additional attestation data, and resultant weighting values, the trained machine learning model results in better predictive performance as compared to a model that had been trained without consideration of the attestation data.

Once training is complete, the example computing device 615 enters the operational phase 702. In some examples, the trained model is distributed from a first computing device (e.g., where training is performed) to a second computing device (e.g., where inference is performed). Such distribution may be performed over the edge cloud 110 to, for example, distribute the model from a first computing device where training is performed (e.g., a device within the network hub 225 of FIG. 2, a device within the core network 235 of FIG. 2, a device within the cloud data center 245 of FIG. 2, etc.) to a second computing device where inference is to be performed (e.g., one or more of the edge devices 210 of FIG. 2, one or more of the devices 200 of FIG. 2, etc.). Such distribution may be performed periodically (e.g., daily, weekly, hourly, etc.) and/or a-periodically (e.g., in response to a need to perform inference, in response to completion of training of a model, etc.).

In the operational phase 702, the example data interface 630 accesses data from varying sources (e.g., edge devices 610, 612, 614) that have different and/or varying attestation data. (Block 730). In this manner, the data on which inference is to be performed may be obtained from different sources having different reliability and/or quality standards. The model thereby enables identification of the data set from a first source as being more trustworthy than a data set from a second source (e.g., a source that lacks attestation data values or having values that differ significantly from their expected values). The example model executor 650 executes the machine learning model stored in the example model data store 660 to create a result for output. (Block 750). The example model execution interface 665 outputs the result of the execution of the machine learning model. (Block 770). The result of the execution of the machine learning model may then be used by an edge node for performance of a task. For example, a task for determining a location of an object (e.g., based on sensor data from sensors having different attestation information) might output the location of the object on a user interface.

The example training initiator 640 determines whether to initiate retraining of the model. (Block 775). Retraining may be triggered upon, for example, a change in the attestation data. In some examples, the training initiator 640 determines that training is not to be performed if, for example, attestation data from one of the edge devices 610, 612, 614 indicates that the edge device is in a non-normal state (e.g., in a debug mode.). If re-training is not to occur (e.g., block 775 returns a result of NO), control returns to block 730, where the operational/inference phase 702 continues. In some examples, additional checks to determine whether to terminate the process 700 of FIG. 7 may additionally be used. For example, the example process 700 of FIG. 7 may be terminated in response to a user request. If re-training is to occur (e.g., block 775 returns a result of YES), control returns to block 705 where re-training occurs. In the illustrated example of FIG. 7, such retraining is illustrated as being performed in an offline fashion (e.g., training is performed while inference is not being performed). In some examples, such re-training may occur in parallel with ongoing inference (e.g., in a live fashion). That is, training may occur in an online fashion. In some examples, to initiate re-training, an instruction is sent to a computing device where training is to be performed. In some examples, additional training data is provided as part of the request to perform training.

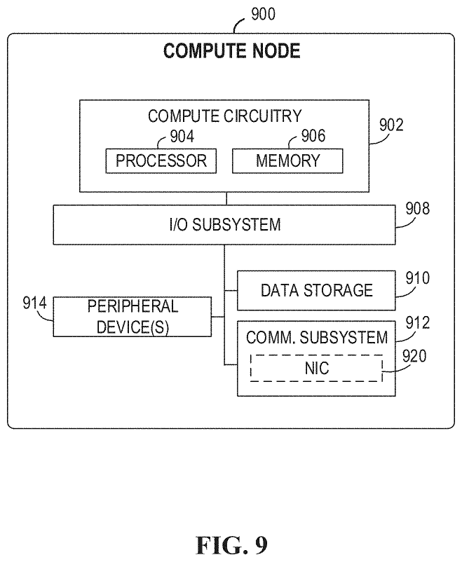

In further examples, any of the compute nodes or devices discussed with reference to the present edge computing systems and environment may be fulfilled based on the components depicted in FIGS. 9 and 10. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 9, an edge compute node 900 includes a compute engine (also referred to herein as “compute circuitry”) 902, an input/output (I/O) subsystem 908, data storage 910, a communication circuitry subsystem 912, and, optionally, one or more peripheral devices 914. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 900 may be embodied as any type of engine, device, or collection of devices capable of performing various compute functions. In some examples, the compute node 900 may be embodied as a single device such as an integrated circuit, an embedded system, a field-programmable gate array (FPGA), a system-on-a-chip (SOC), or other integrated system or device. In the illustrative example, the compute node 900 includes or is embodied as a processor 904 and a memory 906. The processor 904 may be embodied as any type of processor capable of performing the functions described herein (e.g., executing an application). For example, the processor 904 may be embodied as a multi-core processor(s), a microcontroller, a processing unit, a specialized or special purpose processing unit, or other processor or processing/controlling circuit.

In some examples, the processor 904 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that a xPU, a SOC, a CPU, and other variations of the processor 904 may work in coordination with each other to execute many types of operations and instructions within and on behalf of the compute node 900.

The memory 906 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three-dimensional (3D) crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 906 may be integrated into the processor 904. The memory 906 may store various software and data used during operation such as one or more applications, data operated on by the application(s), libraries, and drivers.

The compute circuitry 902 is communicatively coupled to other components of the compute node 900 via the I/O subsystem 908, which may be embodied as circuitry and/or components to facilitate input/output operations with the compute circuitry 902 (e.g., with the processor 904 and/or the main memory 906) and other components of the compute circuitry 902. For example, the I/O subsystem 908 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 908 may form a portion of a system-on-a-chip (SoC) and be incorporated, along with one or more of the processor 904, the memory 906, and other components of the compute circuitry 902, into the compute circuitry 902.

The one or more illustrative data storage devices 910 may be embodied as any type of devices configured for short-term or long-term storage of data such as, for example, memory devices and circuits, memory cards, hard disk drives, solid-state drives, or other data storage devices. Individual data storage devices 910 may include a system partition that stores data and firmware code for the data storage device 910. Individual data storage devices 910 may also include one or more operating system partitions that store data files and executables for operating systems depending on, for example, the type of compute node 900.

The communication circuitry 912 may be embodied as any communication circuit, device, or collection thereof, capable of enabling communications over a network between the compute circuitry 902 and another compute device (e.g., an edge gateway of an implementing edge computing system). The communication circuitry 912 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 912 includes a network interface controller (NIC) 920, which may also be referred to as a host fabric interface (HFI). The NIC 920 may be embodied as one or more add-in-boards, daughter cards, network interface cards, controller chips, chipsets, or other devices that may be used by the compute node 900 to connect with another compute device (e.g., an edge gateway node). In some examples, the NIC 920 may be embodied as part of a system-on-a-chip (SoC) that includes one or more processors, or included on a multichip package that also contains one or more processors. In some examples, the NIC 920 may include a local processor (not shown) and/or a local memory (not shown) that are both local to the NIC 920. In such examples, the local processor of the NIC 920 may be capable of performing one or more of the functions of the compute circuitry 902 described herein. Additionally, or alternatively, in such examples, the local memory of the NIC 920 may be integrated into one or more components of the client compute node at the board level, socket level, chip level, and/or other levels.

Additionally, in some examples, a respective compute node 900 may include one or more peripheral devices 914. Such peripheral devices 914 may include any type of peripheral device found in a compute device or server such as audio input devices, a display, other input/output devices, interface devices, and/or other peripheral devices, depending on the particular type of the compute node 900. In further examples, the compute node 900 may be embodied by a respective edge compute node (whether a client, gateway, or aggregation node) in an edge computing system or like forms of appliances, computers, subsystems, circuitry, or other components.

In a more detailed example, FIG. 10 illustrates a block diagram of an example of components that may be present in an edge computing node 1050 for implementing the techniques (e.g., operations, processes, methods, and methodologies) described herein. This edge computing node 1050 provides a closer view of the respective components of node 900 when implemented as or as part of a computing device (e.g., as a mobile device, a base station, server, gateway, etc.). The edge computing node 1050 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 1050, or as components otherwise incorporated within a chassis of a larger system.

The edge computing device 1050 may include processing circuitry in the form of a processor 1052, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 1052 may be a part of a system on a chip (SoC) in which the processor 1052 and other components are formed into a single integrated circuit, or a single package, such as the Edison™ or Galileo™ SoC boards from Intel Corporation, Santa Clara, Calif. As an example, the processor 1052 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, Calif., a MIPS®-based design from MIPS Technologies, Inc. of Sunnyvale, Calif., an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 1052 and accompanying circuitry may be provided in a single socket form factor, multiple socket form factor, or a variety of other formats, including in limited hardware configurations or configurations that include fewer than all elements shown in FIG. 10.

The processor 1052 may communicate with a system memory 1054 over an interconnect 1056 (e.g., a bus). Any number of memory devices may be used to provide for a given amount of system memory. As examples, the memory 754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1058 may also couple to the processor 1052 via the interconnect 1056. In an example, the storage 1058 may be implemented via a solid-state disk drive (SSDD). Other devices that may be used for the storage 1058 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 1058 may be on-die memory or registers associated with the processor 1052. However, in some examples, the storage 1058 may be implemented using a micro hard disk drive (HDD). Further, any number of new technologies may be used for the storage 1058 in addition to, or instead of, the technologies described, such resistance change memories, phase change memories, holographic memories, or chemical memories, among others.

The components may communicate over the interconnect 1056. The interconnect 1056 may include any number of technologies, including industry standard architecture (ISA), extended ISA (EISA), peripheral component interconnect (PCI), peripheral component interconnect extended (PCIx), PCI express (PCIe), or any number of other technologies. The interconnect 1056 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 1056 may couple the processor 1052 to a transceiver 1066, for communications with the connected edge devices 1062. The transceiver 1066 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 1062. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 1066 (or multiple transceivers) may communicate using multiple standards or radios for communications at a different range. For example, the edge computing node 1050 may communicate with close devices, e.g., within about 10 meters, using a local transceiver based on Bluetooth Low Energy (BLE), or another low power radio, to save power. More distant connected edge devices 1062, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 1066 (e.g., a radio transceiver) may be included to communicate with devices or services in a cloud (e.g., an edge cloud 1095) via local or wide area network protocols. The wireless network transceiver 1066 may be a low-power wide-area (LPWA) transceiver that follows the IEEE 802.15.4, or IEEE 802.15.4g standards, among others. The edge computing node 1050 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 1066, as described herein. For example, the transceiver 1066 may include a cellular transceiver that uses spread spectrum (SPA/SAS) communications for implementing high-speed communications. Further, any number of other protocols may be used, such as Wi-Fi® networks for medium speed communications and provision of network communications. The transceiver 1066 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 1068 may be included to provide a wired communication to nodes of the edge cloud 1095 or to other devices, such as the connected edge devices 1062 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 1068 may be included to enable connecting to a second network, for example, a first NIC 1068 providing communications to the cloud over Ethernet, and a second NIC 1068 providing communications to other devices over another type of network.

Given the variety of types of applicable communications from the device to another component or network, applicable communications circuitry used by the device may include or be embodied by any one or more of components 1064, 1066, 1068, or 1070. Accordingly, in various examples, applicable means for communicating (e.g., receiving, transmitting, etc.) may be embodied by such communications circuitry.

The edge computing node 1050 may include or be coupled to acceleration circuitry 1064, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 1056 may couple the processor 1052 to a sensor hub or external interface 1070 that is used to connect additional devices or subsystems. The devices may include sensors 1072, such as accelerometers, level sensors, flow sensors, optical light sensors, camera sensors, temperature sensors, global navigation system (e.g., GPS) sensors, pressure sensors, barometric pressure sensors, and the like. The hub or interface 1070 further may be used to connect the edge computing node 1050 to actuators 1074, such as power switches, valve actuators, an audible sound generator, a visual warning device, and the like.

In some optional examples, various input/output (I/O) devices may be present within or connected to, the edge computing node 1050. For example, a display or other output device 1084 may be included to show information, such as sensor readings or actuator position. An input device 1086, such as a touch screen or keypad may be included to accept input. An output device 1084 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 1050. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 1076 may power the edge computing node 1050, although, in examples in which the edge computing node 1050 is mounted in a fixed location, it may have a power supply coupled to an electrical grid, or the battery may be used as a backup or for temporary capabilities. The battery 1076 may be a lithium ion battery, or a metal-air battery, such as a zinc-air battery, an aluminum-air battery, a lithium-air battery, and the like.

A battery monitor/charger 1078 may be included in the edge computing node 1050 to track the state of charge (SoCh) of the battery 1076, if included. The battery monitor/charger 1078 may be used to monitor other parameters of the battery 1076 to provide failure predictions, such as the state of health (SoH) and the state of function (SoF) of the battery 1076. The battery monitor/charger 1078 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 1078 may communicate the information on the battery 1076 to the processor 1052 over the interconnect 1056. The battery monitor/charger 1078 may also include an analog-to-digital (ADC) converter that enables the processor 1052 to directly monitor the voltage of the battery 1076 or the current flow from the battery 1076. The battery parameters may be used to determine actions that the edge computing node 1050 may perform, such as transmission frequency, mesh network operation, sensing frequency, and the like.

A power block 1080, or other power supply coupled to a grid, may be coupled with the battery monitor/charger 1078 to charge the battery 1076. In some examples, the power block 1080 may be replaced with a wireless power receiver to obtain the power wirelessly, for example, through a loop antenna in the edge computing node 1050. A wireless battery charging circuit, such as an LTC4020 chip from Linear Technologies of Milpitas, Calif., among others, may be included in the battery monitor/charger 1078. The specific charging circuits may be selected based on the size of the battery 1076, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1058 may include instructions 1082 in the form of software, firmware, or hardware commands to implement the techniques described herein. Although such instructions 1082 are shown as code blocks included in the memory 1054 and the storage 1058, it may be understood that any of the code blocks may be replaced with hardwired circuits, for example, built into an application specific integrated circuit (ASIC).

In an example, the instructions 1082 provided via the memory 1054, the storage 1058, or the processor 1052 may be embodied as a non-transitory, machine-readable medium 1060 including code to direct the processor 1052 to perform electronic operations in the edge computing node 1050. The processor 1052 may access the non-transitory, machine-readable medium 1060 over the interconnect 1056. For instance, the non-transitory, machine-readable medium 1060 may be embodied by devices described for the storage 1058 or may include specific storage units such as optical disks, flash drives, or any number of other hardware devices. The non-transitory, machine-readable medium 1060 may include instructions to direct the processor 1052 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 1082 on the processor 1052 (separately, or in combination with the instructions 1082 of the machine readable medium 1060) may configure execution or operation of a trusted execution environment (TEE) 1090. In an example, the TEE 1090 operates as a protected area accessible to the processor 1052 for secure execution of instructions and secure access to data. Various implementations of the TEE 1090, and an accompanying secure area in the processor 1052 or the memory 1054 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 1050 through the TEE 1090 and the processor 1052.

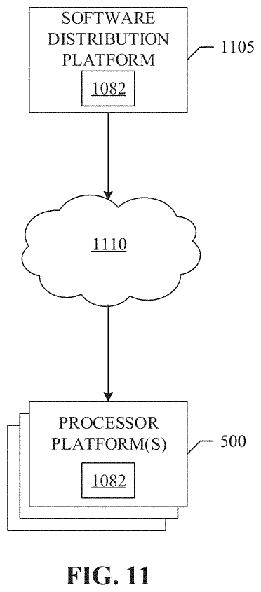

A block diagram illustrating an example software distribution platform 1105 to distribute software such as the example computer readable instructions 1082 of FIG. 10 to third parties is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform. For example, the entity that owns and/or operates the software distribution platform may be a developer, a seller, and/or a licensor of software such as the example computer readable instructions 1082 of FIG. 10. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the computer readable instructions 1082, which may correspond to the example computer readable instructions 700 of FIG. 7, as described above. The one or more servers of the example software distribution platform 1205 are in communication with a network 1210, which may correspond to any one or more of the Internet and/or any of the example networks (e.g., the network 620) described above.

In some examples, the one or more servers are responsive to requests to transmit the software to a requesting party as part of a commercial transaction. Payment for the delivery, sale and/or license of the software may be handled by the one or more servers of the software distribution platform and/or via a third party payment entity. The servers enable purchasers and/or licensors to download the computer readable instructions 1082 from the software distribution platform 1105. For example, the software, which may correspond to the example computer readable instructions 700 of FIG. 7, may be downloaded to the example processor platform 1000, which is to execute the computer readable instructions 1082 to implement the example computing device of FIG. 6. In some example, one or more servers of the software distribution platform 1105 periodically offer, transmit, and/or force updates to the software (e.g., the example computer readable instructions 1082 of FIG. 10) to ensure improvements, patches, updates, etc. are distributed and applied to the software at the end user devices.

From the foregoing, it will be appreciated that example methods, apparatus and articles of manufacture have been disclosed that enable attestation information to be integrated into machine learning models. This has the resultant effect of enabling the machine learning model to generate an output based on the attestation data. As a result, changes in sensors and their corresponding attestation data can be accounted for in the machine learning model. The disclosed methods, apparatus and articles of manufacture improve the efficiency of using a computing device by including attestation data in the metrics used by a machine learning model. The disclosed methods, apparatus and articles of manufacture are accordingly directed to one or more improvement(s) in the functioning of a computer.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

Example methods, apparatus, systems, and articles of manufacture to train a model using attestation data are disclosed herein. Further examples and combinations thereof include the following:

Example 1 includes an apparatus for use of attestation information with a machine learning model, the apparatus comprising memory, instructions, and at least one processor to execute machine readable instructions to at least access training data originating from an edge device, the training data including telemetry information and attestation information, determine a weighting value to be used for the telemetry information based on the attestation information associated with the edge device, and train a machine learning model based on the telemetry information and the weighting value.

Example 2 includes the apparatus of example 1, wherein the edge device is a first edge device, and the processor is further to execute the machine readable instructions to access second data collected by a second edge device, the second data including second attestation information associated with the second edge device, and execute the machine learning model based at least in part on the second attestation information.

Example 3 includes the apparatus of example 2, wherein the second edge device is the first edge device.

Example 4 includes the apparatus of any one of examples 1-3, wherein the machine learning model is to accept attestation information as an input.

Example 5 includes the apparatus of any one of examples 1-4, wherein the processor is further to determine the weighting value based on domain knowledge.

Example 6 includes the apparatus of any one of examples 1-5, wherein the processor is to determine the weighting value based on a reliability of the edge device.

Example 7 includes the apparatus of example 1, wherein the edge device represents a sensor and the attestation information represents a reliability of the sensor.

Example 8 includes the apparatus of any one of examples 1-7, wherein the processor is further to distribute the machine learning model to a second edge device.

Example 9 includes at least one non-transitory computer readable medium comprising instructions that, when executed, cause at least one processor to at least access training data originating from an edge device, the training data including telemetry information and attestation information, determine a weighting value to be used for the telemetry information based on the attestation information associated with the edge device, and train a machine learning model based on the telemetry information and the weighting value.

Example 10 includes the at least one non-transitory computer readable medium of example 9, wherein the edge device is a first edge device, and the instructions, when executed, cause the at least one processor to access second data collected by a second edge device, the second data including second attestation information associated with the second edge device, and execute the machine learning model based at least in part on the second attestation information.

Example 11 includes the at least one non-transitory computer readable medium of example 10, wherein the second edge device is the first edge device.

Example 12 includes the at least one non-transitory computer readable medium of any one of examples 9-11, wherein the machine learning model is to accept attestation information as an input.

Example 13 includes the at least one non-transitory computer readable medium of any one of examples 9-12, and the instructions, when executed, cause the at least one processor to determine the weighting value based on domain knowledge.

Example 14 includes the at least one non-transitory computer readable medium of any one of examples 9-13, and the instructions, when executed, cause the at least one processor to determine the weighting value based on a reliability of the edge device.

Example 15 includes the at least one non-transitory computer readable medium of example 9, wherein the edge device represents a sensor and the attestation data represents a reliability of the sensor.

Example 16 includes the at least one non-transitory computer readable medium of any one of examples 9-15, wherein the processor is further to distribute the machine learning model to a second edge device.

Example 17 includes a method for using attestation information with a machine learning model, the method comprising accessing training data originating from an edge device, the training data including telemetry information and attestation information, determining, by executing an instruction with at least one processor, a weighting value to be used for the telemetry information based on the attestation information associated with the edge device, and training a machine learning model based on the telemetry information and the weighting value.

Example 18 includes the method of example 17, wherein the edge device is a first edge device, and further including accessing second data collected by a second edge device, the second data including second attestation information associated with the second edge device, and executing the machine learning model based at least in part on the second attestation information.

Example 19 includes the method of example 18, wherein the second edge device is the first edge device.

Example 20 includes the method of any one of examples 17-19, wherein the machine learning model is to accept attestation information as an input.

Example 21 includes the method of any one of examples 17-20, wherein the determining of the weighting value is based on domain knowledge.

Example 22 includes the method of any one of examples 17-21, wherein the determining of the weighting value is based on a reliability of the edge device.

Example 23 includes the method of any one of examples 17-22, wherein the edge device represents a sensor and the attestation data represents a reliability of the sensor.

Example 24 includes the method of any one of examples 17-23, further including distributing the machine learning model to a second edge device.

Example 25 includes an apparatus for use of attestation information with a machine learning model, the apparatus comprising means for accessing training data originating from an edge device, the training data including telemetry information and attestation information, means for determining a weighting value to be used for the telemetry information based on the attestation information associated with the edge device, and means for training a machine learning model based on the telemetry information and the weighting value.

Example 26 includes the apparatus of example 25, wherein the edge device is a first edge device, the means for accessing is to access second data collected by a second edge device, the second data including second attestation information associated with the second edge device, and further including means for executing the machine learning model based at least in part on the second attestation information.

Example 27 includes the apparatus of example 26, wherein the second edge device is the first edge device.

Example 28 includes the apparatus of any one of examples 25-27, wherein the machine learning model is to accept attestation information as an input.

Example 29 includes the apparatus of any one of examples 25-28, wherein the means for determining is to determine the weighting value based on domain knowledge.

Example 30 includes the apparatus of any one of examples 25-29, wherein the means for determining is to determine the weighting value based on a reliability of the edge device.

Example 31 includes the apparatus of any one of examples 25-30, wherein the edge device represents a sensor and the attestation data represents a reliability of the sensor.

Example 32 includes the apparatus of any one of examples 25-31, further including means for distributing the machine learning model to a second edge device.

Example 33 includes an apparatus for use of attestation information with a machine learning model, the apparatus comprising a data interface to access training data originating from an edge device, the training data including telemetry information and attestation information, a weighting determiner to determine a weighting value to be used for the telemetry information based on the attestation information associated with the edge device, and a model trainer to train a machine learning model based on the telemetry information and the weighting value.

Example 34 includes the apparatus of example 33, wherein the edge device is a first edge device, the data interface is to access second data collected by a second edge device, the second data including second attestation information associated with the second edge device, and further including a model executor to execute the machine learning model based at least in part on the second attestation information.

Example 35 includes the apparatus of example 34, wherein the second edge device is the first edge device.

Example 36 includes the apparatus of any one of examples 33-35, wherein the machine learning model is to accept attestation information as an input.

Example 37 includes the apparatus of any one of examples 33-36, wherein the weighting determiner is to determine the weighting value based on domain knowledge.

Example 38 includes the apparatus of any one of examples 33-37, wherein the weighting determiner is to determine the weighting value based on a reliability of the edge device.

Example 39 includes the apparatus of any one of examples 33-38, wherein the edge device represents a sensor and the attestation data represents a reliability of the sensor.

Example 40 includes the apparatus of any one of examples 33-39, further including a model execution interface to distribute the machine learning model to a second edge device.

Example 41 is at least one machine-readable medium including instructions that, when executed by processing circuitry, cause the processing circuitry to perform operations to implement any of Examples 1-40.

Example 42 is an apparatus comprising means to implement any of Examples 1-40.

Example 43 is a system to implement any of Examples 1-40.

Example 44 is a method to implement any of Examples 1-40.

Example 45 is a multi-tier edge computing system, comprising a plurality of edge computing nodes provided among on-premise edge, network access edge, or near edge computing settings, the plurality of edge computing nodes configured to perform any of the methods of Examples 1-40.

Example 46 is an edge computing system, comprising a plurality of edge computing nodes, each of the plurality of edge computing nodes configured to perform any of the methods of Examples 1-40.

Example 47 is an edge computing node, operable as a server hosting the service and a plurality of additional services in an edge computing system, configured to perform any of the methods of Examples 1-40.

Example 48 is an edge computing node, operable in a layer of an edge computing network as an aggregation node, network hub node, gateway node, or core data processing node, configured to perform any of the methods of Examples 1-40.

Example 49 is an edge provisioning, orchestration, or management node, operable in an edge computing system, configured to implement any of the methods of Examples 1-40.

Example 50 is an edge computing network, comprising networking and processing components configured to provide or operate a communications network, to enable an edge computing system to implement any of the methods of Examples 1-40.

Example 51 is an access point, comprising networking and processing components configured to provide or operate a communications network, to enable an edge computing system to implement any of the methods of Examples 1-40.

Example 52 is a base station, comprising networking and processing components configured to provide or operate a communications network, configured as an edge computing system to implement any of the methods of Examples 1-40.

Example 53 is a road-side unit, comprising networking components configured to provide or operate a communications network, configured as an edge computing system to implement any of the methods of Examples 1-40.

Example 54 is an on-premise server, operable in a private communications network distinct from a public edge computing network, configured as an edge computing system to implement any of the methods of Examples 1-40.

Example 55 is a 3GPP 4G/LTE mobile wireless communications system, comprising networking and processing components configured as an edge computing system to implement any of the methods of Examples 1-40.

Example 56 is a 5G network mobile wireless communications system, comprising networking and processing components configured as an edge computing system to implement any of the methods of Examples 1-40.

Example 57 is an edge computing system configured as an edge mesh, provided with a microservice cluster, a microservice cluster with sidecars, or linked microservice clusters with sidecars, configured to implement any of the methods of Examples 1-40.

Example 58 is an edge computing system, comprising circuitry configured to implement services with one or more isolation environments provided among dedicated hardware, virtual machines, containers, or virtual machines on containers, the edge computing system configured to implement any of the methods of Examples 1-40.

Example 59 is an edge computing system, comprising networking and processing components to communicate with a user equipment device, client computing device, provisioning device, or management device to implement any of the methods of Examples 1-40.

Example 60 is networking hardware with network functions implemented thereupon, operable within an edge computing system, the network functions configured to implement any of the methods of Examples 1-40.

Example 61 is acceleration hardware with acceleration functions implemented thereupon, operable in an edge computing system, the acceleration functions configured to implement any of the methods of Examples 1-40.

Example 62 is storage hardware with storage capabilities implemented thereupon, operable in an edge computing system, the storage hardware configured to implement any of the methods of Examples 1-40.

Example 63 is computation hardware with compute capabilities implemented thereupon, operable in an edge computing system, the computation hardware configured to implement any of the methods of Examples 1-40.

Example 64 is an edge computing system configured to implement services with any of the methods of Examples 1-40, with the services relating to one or more of: compute offload, data caching, video processing, network function virtualization, radio access network management, augmented reality, virtual reality, autonomous driving, vehicle assistance, vehicle communications, industrial automation, retail services, manufacturing operations, smart buildings, energy management, internet of things operations, object detection, speech recognition, healthcare applications, gaming applications, or accelerated content processing.

Example 65 is an apparatus of an edge computing system comprising: one or more processors and one or more computer-readable media comprising instructions that, when executed by the one or more processors, cause the one or more processors to perform any of the methods of Examples 1-40.

Example 66 is one or more computer-readable storage media comprising instructions to cause an electronic device of an edge computing system, upon execution of the instructions by one or more processors of the electronic device, to perform any of the methods of Examples 1-40.

Example 67 is a computer program used in an edge computing system, the computer program comprising instructions, wherein execution of the program by a processing element in the edge computing system is to cause the processing element to perform any of the methods of Examples 1-40.

Example 68 is an edge computing appliance device operating as a self-contained processing system, comprising a housing, case, or shell, network communication circuitry, storage memory circuitry, and processor circuitry adapted to perform any of the methods of Examples 1-40.

Example 69 is an apparatus of an edge computing system comprising means to perform any of the methods of Examples 1-40.

Example 70 is an apparatus of an edge computing system comprising logic, modules, or circuitry to perform any of the methods of Examples 1-40.

Example 71 is an edge computing system, including respective edge processing devices and nodes to invoke or perform any of the operations of Examples 1-40, or other subject matter described herein.

Example 72 is a client endpoint node, operable to invoke or perform the operations of any of Examples 1-40, or other subject matter described herein.

Example 73 is an aggregation node, network hub node, gateway node, or core data processing node, within or coupled to an edge computing system, operable to invoke or perform the operations of any of Examples 1-40, or other subject matter described herein.

Example 74 is an access point, base station, road-side unit, street-side unit, or on-premise unit, within or coupled to an edge computing system, operable to invoke or perform the operations of any of Examples 1-40, or other subject matter described herein.

Example 75 is an edge provisioning node, service orchestration node, application orchestration node, or multi-tenant management node, within or coupled to an edge computing system, operable to invoke or perform the operations of any of Examples 1-40, or other subject matter described herein.

Example 76 is an edge node operating an edge provisioning service, application or service orchestration service, virtual machine deployment, container deployment, function deployment, and compute management, within or coupled to an edge computing system, operable to invoke or perform the operations of any of Examples 1-40, or other subject matter described herein.

Example 77 is an edge computing system including aspects of network functions, acceleration functions, acceleration hardware, storage hardware, or computation hardware resources, operable to invoke or perform the use cases discussed herein, with use of any Examples 1-40, or other subject matter described herein.

Example 78 is an edge computing system adapted for supporting client mobility, vehicle-to-vehicle (V2V), vehicle-to-everything (V2X), or vehicle-to-infrastructure (V2I) scenarios, and optionally operating according to European Telecommunications Standards Institute (ETSI) Multi-Access Edge Computing (MEC) specifications, operable to invoke or perform the use cases discussed herein, with use of any of Examples 1-40, or other subject matter described herein.

Example 79 is an edge computing system adapted for mobile wireless communications, including configurations according to a 3GPP 4G/LTE or 5G network capabilities, operable to invoke or perform the use cases discussed herein, with use of any of Examples 1-40, or other subject matter described herein.

Example 80 is an edge computing node, operable in a layer of an edge computing network or edge computing system as an aggregation node, network hub node, gateway node, or core data processing node, operable in a close edge, local edge, enterprise edge, on-premise edge, near edge, middle, edge, or far edge network layer, or operable in a set of nodes having common latency, timing, or distance characteristics, operable to invoke or perform the use cases discussed herein, with use of any of Examples 1-40, or other subject matter described herein.

Example 81 is networking hardware, acceleration hardware, storage hardware, or computation hardware, with capabilities implemented thereupon, operable in an edge computing system to invoke or perform the use cases discussed herein, with use of any of Examples 1-40, or other subject matter described herein.

Example 82 is an apparatus of an edge computing system comprising: one or more processors and one or more computer-readable media comprising instructions that, when deployed and executed by the one or more processors, cause the one or more processors to invoke or perform the use cases discussed herein, with use of any of Examples 1-40, or other subject matter described herein.

Example 83 is one or more computer-readable storage media comprising instructions to cause an electronic device of an edge computing system, upon execution of the instructions by one or more processors of the electronic device, to invoke or perform the use cases discussed herein, with use of any of Examples 1-40, or other subject matter described herein.

Example 84 is an apparatus of an edge computing system comprising means, logic, modules, or circuitry to invoke or perform the use cases discussed herein, with the use of any of Examples 1-40, or other subject matter described herein.

It is noted that this patent claims priority from U.S. Provisional Patent Application No. 63/026,666, which was filed on May 18, 2020, and is hereby incorporated by reference in its entirety.

The following claims are hereby incorporated into this Detailed Description by this reference, with each claim standing on its own as a separate embodiment of the present disclosure.

1-42. (canceled)

43. An apparatus for use of attestation information with a machine learning model, the apparatus comprising:
interface circuitry;
instructions; and
at least one processor to execute machine readable instructions to at least:
access training data originating from an edge device, the training data including telemetry information and attestation information;
determine a weighting value to be used for the telemetry information based on the attestation information associated with the edge device; and
train a machine learning model based on the telemetry information and the weighting value.

44. The apparatus of claim 43, wherein the edge device is a first edge device, and the processor is further to execute the machine readable instructions to:
access second data collected by a second edge device, the second data including second attestation information associated with the second edge device; and
execute the machine learning model based at least in part on the second attestation information.

45. The apparatus of claim 44, wherein the second edge device is the first edge device.

46. The apparatus of claim 43, wherein the machine learning model is to accept attestation information as an input.

47. The apparatus of claim 43, wherein the processor is further to determine the weighting value based on domain knowledge.

48. The apparatus of claim 43, wherein the processor is to determine the weighting value based on a reliability of the edge device.

49. The apparatus of claim 43, wherein the edge device represents a sensor and the attestation information represents a reliability of the sensor.

50. The apparatus of claim 43, wherein the processor is further to distribute the machine learning model to a second edge device.

51. At least one non-transitory computer readable medium comprising instructions that, when executed, cause at least one processor to at least:
access training data originating from an edge device, the training data including telemetry information and attestation information;
determine a weighting value to be used for the telemetry information based on the attestation information associated with the edge device; and
train a machine learning model based on the telemetry information and the weighting value.

52. The at least one non-transitory computer readable medium of claim 51, wherein the edge device is a first edge device, and the instructions, when executed, cause the at least one processor to:
access second data collected by a second edge device, the second data including second attestation information associated with the second edge device; and
execute the machine learning model based at least in part on the second attestation information.

53. The at least one non-transitory computer readable medium of claim 52, wherein the second edge device is the first edge device.

54. The at least one non-transitory computer readable medium of claim 51, wherein the machine learning model is to accept attestation information as an input.

55. The at least one non-transitory computer readable medium of claim 51, and the instructions, when executed, cause the at least one processor to determine the weighting value based on domain knowledge.

56. The at least one non-transitory computer readable medium of claim 51, and the instructions, when executed, cause the at least one processor to determine the weighting value based on a reliability of the edge device.

57. The at least one non-transitory computer readable medium of claim 51, wherein the edge device represents a sensor and the attestation data represents a reliability of the sensor.

58. The at least one non-transitory computer readable medium of claim 51, wherein the processor is further to distribute the machine learning model to a second edge device.

59. A method for using attestation information with a machine learning model, the method comprising:
accessing training data originating from an edge device, the training data including telemetry information and attestation information;
determining, by executing an instruction with at least one processor, a weighting value to be used for the telemetry information based on the attestation information associated with the edge device; and
training a machine learning model based on the telemetry information and the weighting value.

60. The method of claim 59, wherein the edge device is a first edge device, and further including:
accessing second data collected by a second edge device, the second data including second attestation information associated with the second edge device; and
executing the machine learning model based at least in part on the second attestation information.

61. The method of claim 60, wherein the second edge device is the first edge device.

62. The method of claim 59, wherein the machine learning model is to accept attestation information as an input.

63. The method of claim 59, wherein the determining of the weighting value is based on domain knowledge.

64. The method of claim 59, wherein the determining of the weighting value is based on a reliability of the edge device.

65. An apparatus for use of attestation information with a machine learning model, the apparatus comprising:
means for accessing training data originating from an edge device, the training data including telemetry information and attestation information;
means for determining a weighting value to be used for the telemetry information based on the attestation information associated with the edge device; and
means for training a machine learning model based on the telemetry information and the weighting value.

66. The apparatus of claim 65, wherein the edge device is a first edge device, the means for accessing is to access second data collected by a second edge device, the second data including second attestation information associated with the second edge device, and further including means for executing the machine learning model based at least in part on the second attestation information.

67. The apparatus of claim 66, wherein the second edge device is the first edge device.
